(19) United States
(12) Patent Application Publication
(10) Pub. No.: US 2011/0153316 A1
(43) Pub. Date: Jun. 23, 2011

(54) Acoustic Perceptual Analysis and Synthesis System

(76) Inventor: Jonathan Pearl, Racine, WI (US)

(21) Appl. No.: 12/643,640

(22) Filed: Dec. 21, 2009

(51) Int. Cl. G10L 19/14; G10L 15/06; G06F 17/30; G06F 3/16

(52) U.S. Cl. 704/205; 704/243; 707/792; 715/727; 707/769; 704/E19.039; 704/E19.04; 707/E17.014; 707/E17.044; 715/764

(57) ABSTRACT

The present invention relates to the field of speech recognition and synthesis, and more specifically to a novel non-phonemically based system for recognizing and synthesizing speech.

### CROSS-REFERENCE TO RELATED APPLICATIONS

None

### FIELD OF INVENTION

The present invention relates to the field of speech recognition and synthesis, and more specifically to a novel non-phonemically based system for recognizing and synthesizing speech.

### BRIEF DESCRIPTION OF THE DRAWINGS

FIG. 1 is a flow chart for an exemplary identification method for APEs which may be implemented on computer hardware.

FIG. 2 is a flowchart of an exemplary embodiment for identifying cycles within an APE which is implemented on computer hardware.

FIG. 3 illustrates an exemplary embodiment of an APE manipulation apparatus.

FIG. 4 illustrates an exemplary method of synthesizing speech using APEs.

FIG. 5 illustrates an exemplary embodiment of an APE data structure.

FIG. 6a illustrates an image of an exemplary APE derived from a speech sample in its original uncompressed form.

FIG. 6b illustrates cycles of an exemplary APE overlaid to demonstrate the change that occurs from cycle to cycle within the APE.

FIG. 6c illustrates the defining cycles of an APE, derived from an exemplary speech sample.

FIG. 6d illustrates an exemplary embodiment of reconstructing an APE of reduced duration by interpolating three intermediate cycles linearly calculated between the defining cycles of an identified APE.

### GLOSSARY

As used herein, the term “acoustic perceptual event” or “APE” means a unit of sound comprised of a start cycle pattern, an end cycle pattern, and the range of change between these patterns. An APE may include any number of intermediate cycles, or no intermediate cycles.

As used herein, the term “APE apparatus” means any machine configured with software and/or hardware adapted to capture, detect, store, categorize, process, synthesize, convert, quantify, isolate or otherwise perform a function related to or compatible with an APE or an activity related to an APE.

As used herein, the term “cohesiveness” or “perceptual cohesiveness” means the quality of a sound rendering the sound distinguishable from surrounding sound events.

As used herein, the term “comparative database” means a database comprised of units of sound which may be compared to other units of sound. For example, a comparative database may include, but is not limited to, APE definitions and descriptions, phonemes, phoneme-based units, musical units of sound, recorded samples of sound, technical descriptions and definitions of sound units, and mathematical or visual representations of sound units.

As used herein, the term “defining cycle” means either a start cycle pattern or an end cycle pattern.

As used herein, the term “cycle pattern”, means a time-delimited set of sequential data points which defines a pattern representing not more than one complete cycle of a speech utterance.

As used herein, the term “end cycle pattern” means a cycle pattern representing the final or terminal portion of an APE or other sound unit.

As used herein, the term “intermediate cycle” means a cycle pattern that falls between a start cycle pattern and an end cycle pattern within an APE or other unit of sound.

As used herein, the term “measurable difference” means any variation between cycle patterns, APEs, or other units of sound that can be quantified.

As used herein, the term “prosody” includes any acoustic perceptual phenomena of speech that is not described by words or grammar. These include phenomena that can be discerned at the phonemic, subphonemic or other levels, not limited merely to those that occur at the suprasegmental level. Examples of prosody include (but are not limited to) rhythm, stress, timing and intonation as evident in all speech, which convey: accent, dialect, or idiolect of the speaker; emotional state or attitude of a speaker; and whether an utterance is a statement, a question, or a command.

As used herein, the term “quantized representation” means a mathematical, numeric or digital description.

As used herein, the term “range of change” means the set of values inclusive of a minimum and maximum value for each point along the cycle patterns being compared, and whether such change increases, decreases, or remains constant, from the first to the second cycle pattern being compared.

As used herein, the term “speech sample” means a recorded or captured utterance or instance of human speech.

As used herein, the term “start cycle pattern” means an initial or first cycle pattern of an APE or other sound unit.

As used herein, the term “subphoneme” is a term known in the art referring to a unit of speech that is a fraction of portion of a phoneme (e.g., demiphones).

### BACKGROUND

Speech recognition and synthesis technologies are applications that recognize or emulate speech. Speech technologies assist human comprehension and are an important means for gathering and transmitting data. Speech technology is a multi-billion dollar a year industry driven by the commercial need for highly accurate and versatile products.

Uses for speech technology are known in the arts of speech science, linguistics and telecommunications. Examples include call centers, GPS navigation, instructional prompts, voice recognition, security authorization tools, reading devices, and enhancements for business and professional technology.

Current speech technology has its roots in experiments from the 1920s, 30s, and 40s and evolved around the concept of phonemes. The phoneme has been inconsistently defined and used. This is because the term is not correlated in the prior art to objective acoustic measures reflecting how sounds are perceived. For example, /l/ is contrasted from /b/ in the words light and bite. However, phonemic definitions provide no objective quantifiable means for measuring the difference between the various pronunciations of /l/.

Speech synthesis technologies generally manipulate base phonetic units called phonemes and units derived from phonemes (e.g., diphones, demiphones, triphones).

These phoneme-based units correspond well to standard linguistic systems of writing. Yet these same writing systems fail to codify the vast wealth of information that is encoded audibly in speech prosody.

Prosody includes non-phonemic attributes of speech such as rhythm, stress, cadence, emphasis, intonation, that greatly aid our ability to understand what is said and what is meant. Both tonal languages and non-tonal languages include prosody.

Many problems are known in the art with regard to current speech synthesis and recognition technologies.

Phoneme-based systems are not capable of recognizing and synthesizing the nuances of everyday speech prosody. Existing speech recognition technologies often fail with non-standard accents.

Phonemic systems have limited ability to recognize and reproduce expressiveness contained within prosody.

Phoneme-based systems lack the fundamental ability to alter rate of speech in synthesis without undue degradation to quality and intelligibility.

Existing Text-to-Speech (TTS) engines at their best render recognizable speech utterances, but are limited in their ability to fully capture and reproduce prosody.

Current speech synthesis protocols (e.g., Speech Synthesis Markup Language or SSML) are not well adapted to handle prosody.

It is desirable to have speech technology methods adapted to identify acoustic events other than phoneme-based units.

It is further desirable to utilize such speech synthesis and recognition methods in devices and systems known in the art to enhance performance of the devices and systems and capture the full range of dialectic and idiolectic (individual) variations and nuances of human speech.

It is further desirable to have a reliable method for speech compression that preserves the perceptual quality of the instance of speech that is compressed, while achieving desired communication capabilities and efficiencies.

### SUMMARY OF THE INVENTION

The present invention is a sound segmentation system and apparatus which utilizes units known as Acoustic Perceptual Events (APEs) rather than phonemes and phoneme-based units. APEs more accurately reflect underlying prosody of human speech than phoneme-based units.

### DETAILED DESCRIPTION OF INVENTION

For the purpose of promoting an understanding of the present invention, references are made in the text to exemplary embodiments of an acoustic perception and synthesis apparatus and system only some of which are described herein. It should be understood that no limitations on the scope of the invention are intended by describing these exemplary embodiments. One of ordinary skill in the art will readily appreciate that alternate but functionally equivalent acoustic perception and synthesis apparatuses and systems may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that various equivalent apparatuses may be used, and that steps for an identified method need not be performed in a particular order.

Acoustic Perceptual Events (APEs) are minimal units of sound characterized by perceptual cohesiveness. They are measured and described in terms of a unified change from the values by phase degree of a beginning pattern to those of an ending pattern. Their essential novelty is that they characterize sound in terms of change, rather than stasis.

Cohesiveness is a term used relative to the present method to describe the audible character of a particular sound as perceived by a listener or listening device as a single, indivisible whole, exhibiting the necessary and sufficient features to evoke a unified percept in the mind of a listener, distinguishable from surrounding sound events.

APEs are novel units of sound which are not found in the prior art, and which are defined by the present invention.

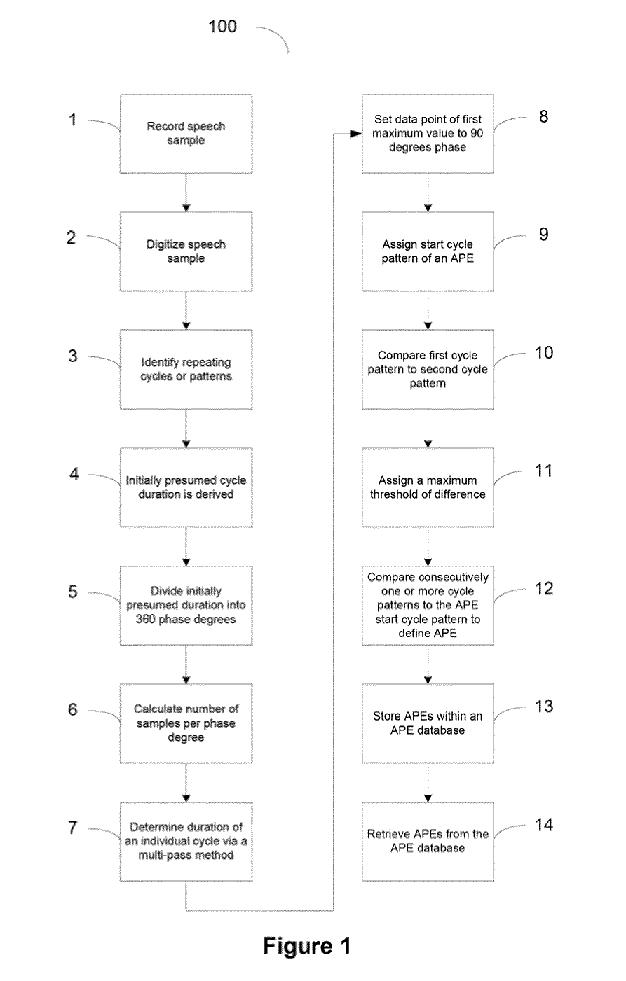

FIG. 1 illustrates an exemplary embodiment of APE identification method 100 for defining sound events as APEs which may be implemented on a single computer, multiple computers, a network and/or a distributed network. APEs are a type of sound unit characterized by perceptual cohesiveness, and are distinct from other units of sound that are known in the art, such as phonemes and phoneme-based units. An APE represents a minimal perceptual unit of sound that can be analyzed from, or combined with other APEs to constitute, larger classifiable units of sound, such as phonemes, morphemes, syllables, and words. Perceptually-based units, such as APEs, are required to handle the full range of speech prosody.

In Step 1 of APE identification method 100, a speech utterance is recorded or captured using any recording means known in the art used to capture and reproduce sound.

In Step 2, the recorded sound is digitized to create a numeric representation that may be depicted as a graph, waveform or other image. In the embodiment shown are graphical or numeric representations of quantized (digital) sound known in the art. For example, Matlab or any commercially known software in the art may produce such representations. A digital (numeric) file is interpreted and represented graphically on an interface, and displays a range of speech activity.

In other embodiments, the recording is presented in a digital format and Step 2 of APE identification method 100 may be eliminated.

In Step 3, human or mechanical means are then used to identify repetition of similar numerical or graphically represented patterns within a speech sample, known as cycles. A cycle means a time-delimited set of sequential data points describing a complete circuit (e.g. a sine wave).

In Step 4, an initially presumed cycle duration is derived. The initially presumed cycle duration is derived by measuring the distance in time from the maximum value of one cycle as identified in Step 3 to a corresponding maximum value of the next consecutive cycle as identified in Step 3.

In Step 5, the initially presumed duration is divided into 360 equal portions known as phase degrees.

In Step 6, the number of samples (data points) per phase degree is calculated by dividing the total number of samples from one maximum value as determined in Step 4 to the next maximum value as determined in Step 4 by 360.

In Step 7, the duration of an individual cycle is determined via a multi-pass method. In the exemplary embodiment, the initially presumed cycle duration of Step 4, and the phase degree calculations of Steps 5 and 6, are used to set a window of 45 phase degrees for the second pass. The center sample (data point) of the initial window is set to reside at least 135 degrees before the beginning of the first maximum value of Step 4. All sample values within the window are averaged, and this value is set as the value for the center data point of the window.

The window then steps ahead by data point, setting the immediately consecutive data point as center for the next window, once again averaging all values within the window and setting this as the value for the center data point. This repeats until reaching a data point at least 135 degrees after the second maximum value used in Step 4.

A second-pass duration is determined as in Step 4, by measuring the distance from maximum value to maximum value, in the second and subsequent passes however using the averaged values rather than the initial values. The second-pass calculation of cycle duration is then used as the basis for a third-pass. The second-pass calculation of cycle duration is used to replace the initially presumed cycle duration of Step 4. Steps 5 and 6 are repeated with this second-pass duration.

In the exemplary embodiment, the same procedure is followed for the third-pass as for the second-pass, only the window for averaging initial values is set at 22.5 phase degrees of the second-pass duration.

In the exemplary embodiment, two subsequent passes are executed following the initial calculation of cycle duration of Step 4. More or fewer passes may be executed, and the size of the windows in phase degrees may vary from those exemplified.

In Step 8, the data point that corresponds to the first maximum value of the final pass of Step 7 is set as 90 degrees phase for the cycle to be defined. Calculated from this 90 degree point, the initial and final samples are set to be 0 and 359 degrees respectively. 360 degrees becomes the first sample (0 degrees) of the subsequent cycle.

In Step 9, one cycle or partial cycle so defined is assigned as the start cycle pattern of an APE as contained in the data of a recorded speech sample.

In the exemplary embodiment, Steps 4 through 8 are repeated one or more times, until at least two cycle patterns have been so defined.

In Step 10, a first cycle pattern as derived in Step 8 is compared by human or mechanical means to a second cycle pattern so defined. This comparison identifies the range of change between them. The range of change is defined as the set of values inclusive of a minimum and maximum value for each point along the cycle patterns being compared, and whether such change increases, decreases, or remains constant, from the first to the second cycle pattern being compared.

These cycles may be of differing durations. They are compared in terms of sample values by phase degree. This facilitates comparison of partial cycles as well, which are defined in terms of the phase degrees they contain.

In Step 11, a maximum threshold of difference is assigned, by human or mechanical means, to constrain the range of change permissible for an APE.

In Step 12, one or more cycle patterns, as derived in Steps 4 through 8 are compared consecutively to the APE start cycle pattern as derived in Step 9, until the maximum threshold of change between cycles, as assigned in Step 11, has been reached. The last cycle before this threshold has been exceeded is defined as the end cycle of an APE.

The start cycle pattern, the end cycle pattern, and the range of change between them define the APE.

In Step 13, any number of APEs may be stored within an APE database, and APE data structures may include any number of intermediate data cycles. APE data structures may be manipulated, supplemented and compressed by adding, removing or interpolating data cycles.

In Step 14, APEs may be retrieved from the APE database for manipulation, analysis, concatenation, compression, reduction or any other speech synthesis related function known in the art.

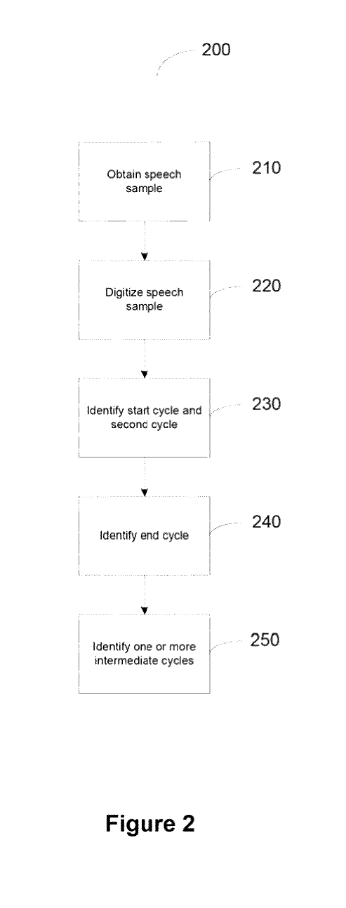

FIG. 2 is a flowchart of APE analysis method 200 for identifying cycles within an APE. Step 210 is the step of capturing a speech sample. Step 220 is the step of digitizing a speech sample. Step 230 is the step of identifying a start cycle and a second cycle (or partial cycle pattern) within a sound stream, and Step 240 is the step of identifying an end cycle. In various embodiments, APE analysis method 200 may also include Step 250 for identifying one or more intermediate cycles (which may or may not be present in all APEs).

In the embodiment shown, APEs fall typically in the range of 20 to 40 milliseconds. Acoustic events shorter than 6 milliseconds are usually too brief to be perceived as anything more than noise. APEs longer than 60 milliseconds are rare because stability and cohesiveness break down. An APE is defined as a circumscribed range of change, encompassing a single perceptually coherent acoustic event.

In the embodiment shown, an APE is sequential, determining a start cycle and an end cycle to define the range of variation, such that intermediate cycles can be considered merely transitional between these boundaries. Removing some or all intermediate cycles, or replacing them with a variable number of interpolations, has little effect on the perceived sound.

In other embodiments, the speech sample is presented in a digital format and Step 220 of APE analysis method 200 may be eliminated.

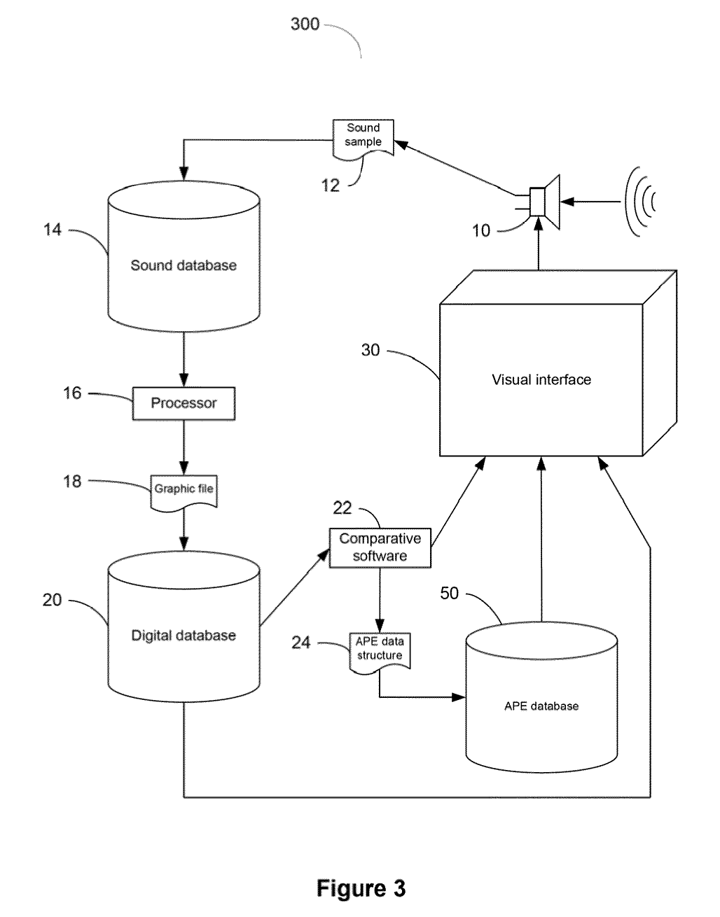

FIG. 3 illustrates an exemplary embodiment of a computer apparatus configured with software and hardware to perform APE identification and manipulation methods, referred to as APE manipulation apparatus 300. APE manipulation apparatus 300 may be implemented on one or multiple hardware devices, processors and distributed on local databases.

In the embodiment shown, APE manipulation apparatus 300 includes sound acquisition means 10 receiving a speech sample which may be any recording device, sound receiver, audio, digitized, analog or other means known in the art for receiving speech sample 12.

Speech sample 12 is stored in a database of speech samples 14. Speech sample may be of any duration and stored in any electronic file format known in the art. In the embodiment shown, manipulation apparatus 300 further includes a speech-to-image processor 16 configured with image software known in the art to produce graphic representation file 18 from sound recordings, which is stored in graphic file database 20.

Graphics file database 20 contains searchable, indexed and standardized graphical representations of sound samples, numeric representations of quantized (digital) sound known in the art. For example, Matlab or any commercially known software in the art may produce such representations. A digital (numeric) file is interpreted by comparative software component 22 and represented graphically on an interface 30. Visual interface 30 may display a range of speech activity.

In various embodiments, visual interface 30 through which a user or mechanical device may view (or scan) and identify repeating cycles and cycle patterns or partial patterns within a speech sample that are similar and repeated throughout the speech sample. Cycles and cycle patterns are discerned based on their degree of similarity as they recur throughout a speech sample.

Comparative software component 22 is used to identify at least two instances of a cycle or partial cycle pattern identified within a speech sample and to determine extent and direction of change in values for each degree of a cycle phase. Several intermediate cycles may also be identified between those cycle patterns being compared. A threshold of change between cycles is assigned to define the maximum acceptable range of change between cycles within an APE.

An APE is then defined as a start cycle pattern, an end cycle pattern, and the set of values by phase degree, which describe the range of change between these defining cycles. An identified APE data structure 24 is then stored in APE database 50.

In embodiment shown, APEs stored in APE database 50 may be retrieved to reconstruct and create speech patterns. APE structures 24 stored in APE database 50 may include but are not limited to .mat, .dat, docx, .wav files, or any type of data file known in the art which is capable of storing data, including those which are proprietary to a specific software program.

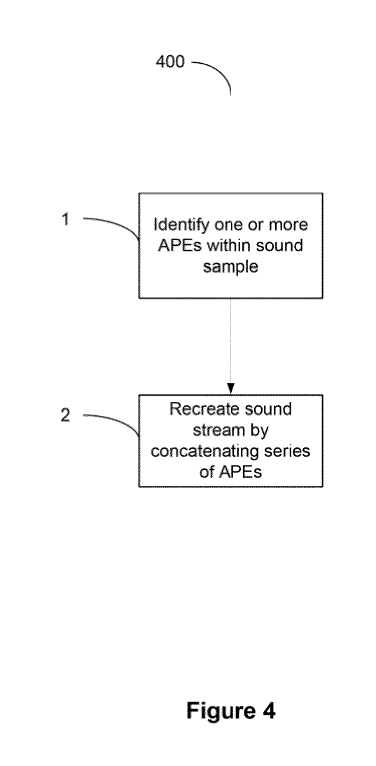

FIG. 4 illustrates exemplary method of synthesizing speech 400 using APEs derived from sound samples or sound streams.

Step 1 consists of identifying one or more APEs present within a sound sample or sound stream.

Step 2 consists of recreating a sound stream by concatenating a series of APEs. APEs may be combined to form any classifiable unit of sound (e.g., phoneme, word, sentence, musical note), including extended speech utterances or sound streams of any conceivable length. The use of APEs permits finer control over all aspects of speech prosody than existing methods allow, including but not limited to subsegmental elements of speech prosody.

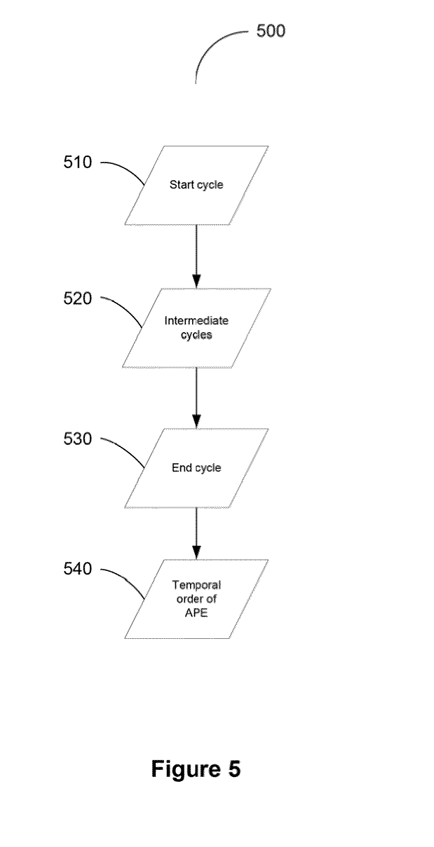

FIG. 5 illustrates an exemplary embodiment of APE data structure 500. In the embodiment shown, APE data structure 500 is comprised of a numerical value representing a start cycle pattern 510 and a numerical value representing an end cycle pattern 530. APE data structure 500 may further include one or more values representing intermediate cycles 520. Exemplary APE data structure 500 may also include value 540 representing the temporal order of the APE within larger structures, such as phonemes, syllables, or words.

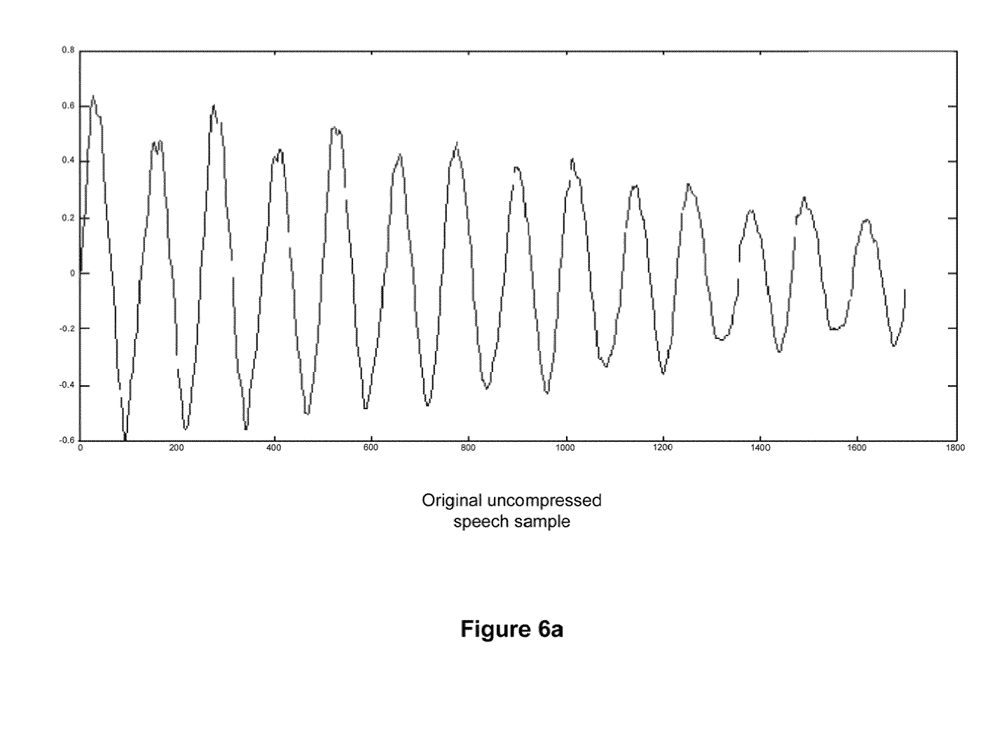

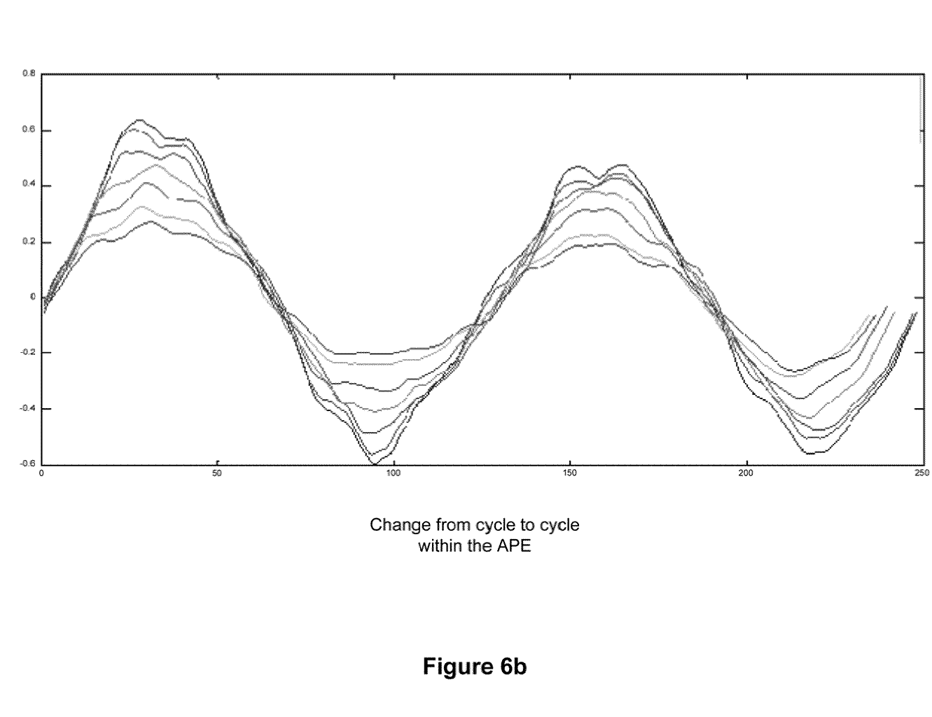

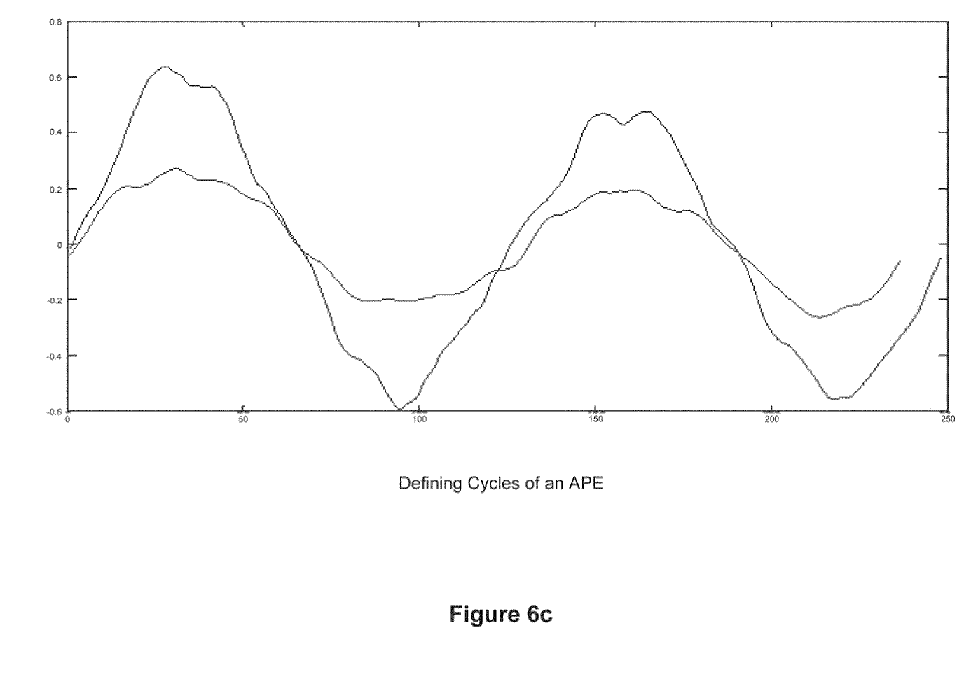

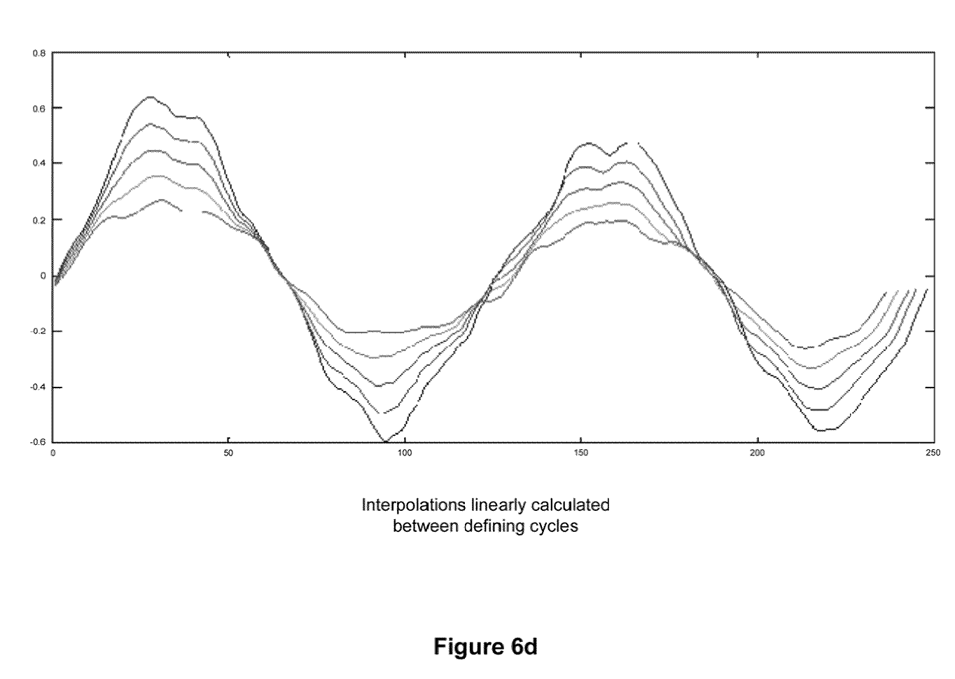

FIGS. 6a through 6d illustrate exemplary images generated by a method for identifying and/or manipulating APEs 600.

FIG. 6a illustrates a speech sample digitally captured in its original uncompressed form. The sample indicated presents a single APE of approximately 38 milliseconds, consisting of 1696 samples taken at 44.1 KHz. The x-axis is the number of samples; the y-axis is amplitude.

FIG. 6b illustrates a graphic representation in which cycles are overlaid to show their relationship and to demonstrate the change that occurs from cycle to cycle within the APE. The x-axis identifies the number of samples, the y-axis indicates amplitude. Amplitude is a term known in the art to describe a mathematical value for air pressure at a given point in space at a given point in time. In this illustration each subsequent cycle begins again at zero, rather than continuing from the end of the previous cycle. Thus time moves left to right, and “front” to “back.”

Cycle duration is determined from multiple passes with varying length windows adjusted to preset degrees of phase of the presumed length for each cycle. The initial presumption of cycle duration is taken as a measure from peak sample to peak sample, determined by amplitude of the raw data. Two or more subsequent passes refine this calculation, with the sample location of the final averaged peak set to 90° phase of the final presumed cycle duration.

Various embodiments of method for identifying and/or manipulating APEs 600 may utilize different numbers of passes and window lengths (based on phase degrees rather than fixed durations) for determining cycle durations. In this exemplary image shown in FIG. 6b, two subsequent passes were made following the initial raw measurement. The first of these used an averaging window set at 45 degrees of the initially presumed duration. A measure of the averaged peak to averaged peak distance is then advanced to the next pass as the refined presumed cycle duration. In the embodiment shown, the second subsequent pass uses a window set at 22.5 degree phase of this refined length to determine cycle duration from averaged peak to averaged peak, and the first of these peaks is set at 90 degrees phase to define an individual cycle. This technique provides greater control and specificity than off-the-shelf methods of cycle extraction.

In a further step, local frequency determined from the final presumed duration of each cycle, provides the means to calculate frequency change through the course of an APE and from cycle-to-cycle. In addition, it provides a consistent means for measuring frequency slope, a crucial factor in describing and comparing APEs. The exemplary embodiment shown is based on a one-peak sine-wave paradigm as the idealized form. In alternate embodiments, multiple paradigms may be utilized to accommodate a wider range of data than a single one-peak paradigm.

In FIG. 6c is a graphic representation of the defining cycles of an APE extracted without their intermediate cycles from the original speech sample.

FIG. 6d is a graphic representation of three interpolations linearly calculated between the defining cycles as shown here and in FIG. 6c, to replace the original five intermediate cycles as illustrated in FIG. 6b, thereby increasing speech rate for this segment by nearly 30%. This synthesized version is perceptually equivalent to the original shown in FIGS. 6a and 6b, despite 60% of it being produced whole cloth. Duration in synthesis by means of APEs can be varied: (1) by removing all intermediate cycles; (2) by calculating and inserting a varied number of interpolations, and (3) by entirely removing less salient APEs.

Various embodiments of method for identifying and/or manipulating APEs 600 may include the incorporation of values by phase degree that lie outside the values contained in the boundary cycles (first and last) of an original sound stream for an APE. Incorporation of these outlying values in the definition of an APE strengthens the flexibility and accuracy of the APE database.

What is claimed is:

1. A computer apparatus which implements a method of manipulating at least one speech sample utilizing APEs comprised of the steps of:
identifying more than one cycle pattern within a speech sample using a quantized representation of said more than one cycle pattern;
comparing a first cycle pattern to at least one other cycle pattern;
repeatedly measuring the change between said first cycle pattern and said at least one other cycle pattern and recording mathematical representation of said change in comparative database;
defining the maximum change between said first cycle pattern and said at least one other cycle pattern which will occur in an APE;
identifying a start cycle pattern which when compared with an end cycle pattern yields a measurable difference, said measurable difference representing the maximum range of change between two cycle patterns in an APE; and
assigning an identifying label to said APE to create at least one labeled APE.

2. The method of claim 1, which further includes the step of recording at least one speech sample.

3. The method of claim 1 which further includes the step of identifying at least one labeled APE within a speech sample.

4. The method of claim 1 which further includes concatenating more than one APE to create a speech sample.

5. The method of claim 1 which further includes the step of manipulating APEs to decrease the duration of a speech sample by removing at least one intermediate cycle pattern.

6. The method of claim 1 which further includes the step of manipulating APEs to increase the duration of a speech sample by adding at least one additional intermediate cycle.

7. The method of claim 1 which further includes the step of reconstructing a speech sample using at least one start cycle and at least one end cycle.

8. The method of claim 1 which further includes the step of reconstructing a speech sample using at least one APE.

9. A computer apparatus for identifying and categorizing APEs comprised of:
a receiver for receiving at least one speech sample;
a first processing component for identifying more than one cycle pattern within said at least one speech sample using a quantized representation of said more than one cycle pattern;
said first processing component being capable of comparing a first cycle pattern to at least one other cycle pattern;
said first processing component being further capable of repeatedly measuring the change between a said first cycle pattern and at least one other cycle pattern and recording mathematical representation of said change in comparative database;
a second processing component capable of identifying the maximum change between said first cycle pattern and said at least one other cycle pattern which will occur in an APE;
a third processing component capable of identifying a start cycle pattern which when compared with an end cycle pattern yields a measurable difference, said measurable difference representing the maximum range of change between two cycle patterns in an APE; and
a fourth processing component capable of assigning an identifying label to said APE to create at least one labeled APE.

10. The apparatus of claim 9 which further includes an APE database.

11. The apparatus of claim 9 which further includes an APE database which may be queried using a digitized representation of an APE selected on said user interface.

12. The apparatus of claim 9 which further includes an APE database which may be queried using a digitized representation of a sound unit.

13. The apparatus of claim 9 which further includes a user interface capable of displaying graphic representations of at least one cycle pattern.

14. The apparatus of claim 9 which further includes a user interface which allows a user to manipulate at least one APE.

15. The apparatus of claim 9 which further includes a user interface which allows a user to combine two or more APEs.

16. The apparatus of claim 9 which further includes a user interface which allows a user to isolate one or more APEs from a speech sample.

17. The apparatus of claim 1 which further includes a user interface which allows a user to compare at least two APEs

18. The apparatus of claim 9 which is implemented on a computer.

19. The apparatus of claim 9 which is comprised of a network of geographically distributed computers.

20. An APE hardware apparatus for storing at least one APE data structure, said APE data structure comprised of the following:
at least one digital representation of an APE start cycle pattern;
at least one digital representation of an APE end cycle pattern; and
a digital representation of the range of change between said at least one digital representation of an APE start cycle pattern and said at least one digital representation of an APE end cycle pattern.

21. The APE hardware apparatus for storing at least one APE data structure of claim 20 wherein said APE data structure further includes at least one APE intermediate cycle pattern.
